(19) United States
(12) Patent Application Publication
(10) Pub. No.: US 2023/0037629 A1
(43) Pub. Date: Feb. 9, 2023

(54) RADIO NODES HAVING BEAM STEERING ANTENNA ARRAYS

(71) Applicant: CommScope Technologies LLC, Hickory, NC (US)

(72) Inventors: Michael L. Brobston, Allen, TX (US); Jonathon C. Veihl, New Lenox, IL (US)

(21) Appl. No.: 17/815,597

(22) Filed: Jul. 28, 2022

Related U.S. Application Data
(60) Provisional application No. 63/229,132, filed on Aug. 4, 2021.

(51) Int. Cl. H01Q 3/24; H04B 7/0426; H01Q 5/335

(52) U.S. Cl. CPC H01Q 3/247; H04B 7/043; H01Q 5/335

(57) ABSTRACT

A radio node includes RF circuitry and an antenna array that includes a plurality of columns of radiating elements, the antenna array coupled to the RF circuitry. The antenna array is configured to have a discrete set of beam states in an elevation plane of the antenna array. A first subset of the discrete set of beam states is associated with the radio node being mounted in a wall mount configuration and a second subset of the discrete set of beam states is associated with radio node being mounted in a ceiling mount configuration.

### CROSS-REFERENCE TO RELATED APPLICATION

The present application claims priority under 35 U.S.C. § 119 to U.S. Provisional Application Ser. No. 63/229,132, filed Aug. 4, 2021, the entire content of which is incorporated herein by reference as if set forth in its entirety.

### FIELD

The present invention generally relates to radio communications and, more particularly, to radio nodes having electronically steerable antenna arrays.

### BACKGROUND

Wireless communications systems such as, for example, cellular communications systems and wireless local area networks (“WLANs”), are well known in the art. In a cellular communications system, a geographic area is divided into a series of regions that are referred to as “cells” which are served by respective base stations. Each base station may include one or more radios and base station antennas. The radios and base station antennas are used to support two-way radio frequency (“RF”) communications with mobile client devices that are within the cell served by the base station. A WLAN refers to a network that operates in a limited area (e.g., within a home, school, store, campus, etc.) that wirelessly interconnects client devices (e.g., smartphones, computers, printers, appliances, etc.) with each other and/or with external networks such as the Internet. Most WLANs operate under standards promulgated by the Institute of Electrical and Electronics Engineers (“IEEE”) that are referred to as the IEEE 802.11 standards, and such WLANs are commonly referred to as WiFi networks. A WiFi network includes one or more radio nodes or “access points” that are installed at fixed locations throughout a coverage area. Client devices communicate with each other and/or with wired devices that are connected to the WiFi network through the access points. The access points may be connected to each other and/or to gateways that may be used to provide Internet access to the client devices.

Many wireless communications systems have radio nodes (e.g., cellular base stations and WiFi access points) that include linear or planar phased arrays of radiating elements that generate radiation patterns that are electronically steerable. A radiation pattern may be omnidirectional, meaning that the gain is similar in all directions (e.g., over a full hemisphere) or may be a directional pattern that has high antenna gain in some directions and lower antenna gain in other directions. Directional radiation patterns typically have a main lobe where the gain is the highest and a plurality of side lobes that have reduced gain. In between the main lobes and the side lobes are typically regions where the gain is very low, which are referred to as nulls. The radiation patterns generated by an antenna array are referred to herein as “antenna beams.” Electronic beam steering can be used to electronically steer the main lobe of an antenna beam in desired directions and/or to narrow the main lobe, thereby increasing the gain of the antenna array in a desired direction while reducing antenna gain in the direction(s) of interference source(s) to minimize the impact of the interference on the active communication links between the radio node and the client devices.

Electronic beam steering is widely used in 5^{th} generation (5G) wireless communications systems. Some 5G wireless communications systems are being deployed that operate in millimeter wave (mmWave) frequency bands, such as, for example, the 24 GHz, 28 GHz and 39 GHz frequency bands. In these frequency bands, 5G communications systems almost always employ electronic beam steering since free space loss at frequencies above about 5 GHz is very high as compared to, for example, the free space loss in the traditional cellular frequency bands (e.g., the 600-2700 MHz frequency range), since building material penetration losses tend to increase with increasing frequency.

Using an outdoor network of radio nodes to provide coverage to in-building wireless users is often a challenge, even in wireless networks operating in frequency bands below 3 GHz, due to the above-referenced building material penetration losses. Unfortunately, in the mmWave frequency bands, the building penetration losses are severe. In order to reduce or avoid these building penetration losses, many mmWave networks are deployed within buildings. In such networks, a plurality of “small cell” mmWave radio nodes are mounted on the ceiling and/or walls of the building. The mmWave radio nodes may include antenna arrays that have electronic beam steering capabilities, and each radio node may provide coverage to a predefined area within the building. By deploying small cell mmWave radio nodes at multiple distributed locations within the building and connecting the radio nodes back to a centralized controller, it is possible to provide virtually ubiquitous mmWave wireless coverage within a building.

To achieve complete coverage within a building, it often is necessary mount some of the mmWave radio nodes on the ceiling(s) of the building and others of the mmWave radio nodes on the walls. For example, wall mounted radio nodes may be well-suited for providing coverage to offices along outer walls of a building, while ceiling mounted radio nodes may be more effective for providing coverage in central regions of a building and in large open areas. The directions in which the antenna beams that are generated by the antenna arrays should point, however, differ for wall-mounted and ceiling-mounted radio nodes. Thus, if a radio node is to be both wall and ceiling mountable, then the radio node preferably should have one or more antenna arrays that are capable of electronically steering the generated antenna beams over any direction within a hemisphere. Unfortunately, antenna arrays in which the radiating elements are mounted on a two dimensional backplane can only electronically steer antenna beams to limited angles off the boresight pointing direction of the antenna array (which is the direction extending outwardly from the center of the array at an angle perpendicular to the plane defined by the two dimensional backplane) while maintaining high gain.

### SUMMARY

Pursuant to embodiments of the present invention, radio nodes are provided that comprise RF circuitry and an antenna array that includes a plurality of columns of radiating elements that is coupled to the RF circuitry. The antenna array is configured to have a discrete set of beam states in an elevation plane of the antenna array. Additionally, a first subset of the discrete set of beam states is associated with the radio node being mounted in a wall mount configuration and a second subset of the discrete set of beam states is associated with the radio node being mounted in a ceiling mount configuration.

In some embodiments, the antenna array may be configured to have a total of two beam states in the elevation plane of the antenna array, and the first subset of the discrete set of beam states may consist of a single first beam state and the second subset of the discrete set of beam states may consist of a single second beam state. In other embodiments, a number of beam states in the discrete set of beam states may be between two and four beam states.

In some embodiments, the radio node may be configured to use the first subset of the discrete set of beam states when the radio node is mounted in the wall mount configuration and to use the second subset of the discrete set of beam states when the radio node is mounted in the ceiling mount configuration.

In some embodiments, the radio node may further comprise a base electronics printed circuit board (“PCB”), and the antenna array may be part of an antenna array module that is mounted on the base electronics PCB.

In some embodiments, the antenna array module may be a first antenna array module of a plurality of antenna array modules that are mounted on the base electronics PCB, and each antenna array module may include a respective antenna array. In some embodiments, the antenna array of the first antenna array module may define a first plane that extends at an angle of between about 30° and about 60° (e.g. 45°) with respect to a major surface of the base electronics PCB.

In some embodiments, the radio node may further comprise a feed network that connects the antenna array to the RF circuitry, and the feed network includes a single phase weighting element for each column of radiating elements in the antenna array.

In some embodiments, each of the radiating elements in a first column of the antenna array may be connected to a feed line, and a phase weighting element associated with the first column is connected to the feed line by at least a first path and a second path. In some embodiments, the first path may connect to a first location on the feed line and the second path may connect to a second location on the feed line, where the first and second locations are separated from each other by a first pre-selected phase shift.

In some embodiments, the first pre-selected phase shift may be a phase shift of about 90°.

In some embodiments, the radio node may be configured to route RF signals between the phase weighting element associated with the first column and the feed line over the first path when the radio node is mounted in the wall mount configuration and over the second path when the radio node is mounted in the ceiling mount configuration. In some embodiments, an antenna beam generated by the antenna array may be continuously scannable in an azimuth plane of the antenna array. In some embodiments, the radio node may be a millimeter wave radio node or a WiFi access point.

Pursuant to further embodiments of the present invention, antenna array modules are provided that comprise an RF input, a power divider having an input that is coupled to the RF input and at least a first output and a second output, an antenna array that includes at least a first column of radiating elements and a second column of radiating elements, a first feed line that connects to each of the radiating elements in the first column of radiating elements, and a second feed line that connects to each of the radiating elements in the second column of radiating elements. The first output of the power divider is connected to the first feed line by a first path and a second path, and the second output of the power divider is connected to the second feed line by a third path and a fourth path.

In some embodiments, the first output of the power divider may be selectively connected to the first feed line by one of the first path and the second path. In some embodiments, the first path may connect to the first feed line at a first location and the second path may connect to the first feed line at a second location that is different from the first location. The first location may be spaced apart from the second location along the first feed line a distance that corresponds to a phase shift of between 45° and 135° (e.g., 90°) for an RF signal having a frequency that corresponds to a center frequency of the operating frequency band of the antenna array. In some embodiments, a top radiating element in the first column may connect to the first feed line at a third location and a bottom radiating element in the first column may connect to the first feed line at a fourth location, and the first location and the second location may both be between the third location and the fourth location. In other embodiments, the first location may be a first end of the first feed line and/or the second location may be a second end of the first feed line.

In some embodiments, a first diode may be coupled to the first path and a second diode may be coupled to the second path, and the first and second diodes may be configured to allow selection of one of the first path and the second path.

In some embodiments, the first output of the power divider may be selectively connected to the first feed line by the first path if a radio node that includes the antenna array is mounted in a wall mount configuration, and may be selectively connected to the first feed line by the second path if the radio node is mounted in a ceiling mount configuration.

Pursuant to still further embodiments of the present invention, radio nodes are provided that, comprise an array of radiating elements that includes at least a first column of radiating elements, a first feed line that connects to each of the radiating elements in the first column of radiating elements, and a first phase weighting element that is selectively coupled to the first feed line via a first path and a second path. The radio node is configured to couple the first phase weighting element to the first feed line via the first path when the radio node is mounted in a wall mount configuration and is configured to couple the first phase weighting element to the first feed line via the second path when the radio node is mounted in a ceiling mount configuration.

In some embodiments, the first path may connect to the first feed line at a first location and the second path may connect to the first feed line at a second location that is different from the first location. In some embodiments, the first location may be spaced apart from the second location along the first feed line a distance that corresponds to a phase shift of between 45° and 135° for an RF signal having a frequency that corresponds to a center frequency of the operating frequency band of the array of radiating elements. In some embodiments, the first location may be spaced apart from the second location along the first feed line a distance that corresponds to a phase shift of about 90° for the RF signal having a frequency that corresponds to the center frequency of the operating frequency band of the array of radiating elements. In some embodiments, a top radiating element in the first column may connect to the first feed line at a third location and a bottom radiating element in the first column may connect to the first feed line at a fourth location, and the first location and the second location may both be between the third location and the fourth location.

In some embodiments, a first diode may be coupled to the first path and a second diode may be coupled to the second path, and the first and second diodes may be configured to allow selection of one of the first path and the second path.

In some embodiments, the first location may be a first end of the first feed line and/or the second location may be a second end of the first feed line.

Pursuant to still further embodiments of the present invention, radio nodes are provided that comprise a base electronics PCB and a plurality of antenna array modules coupled to the base electronics PCB. Each antenna array module is mounted at an angle of between about 30° and about 60° with respect to a plane defined by a major surface of the base electronics PCB.

### DETAILED DESCRIPTION OF THE FIGURES

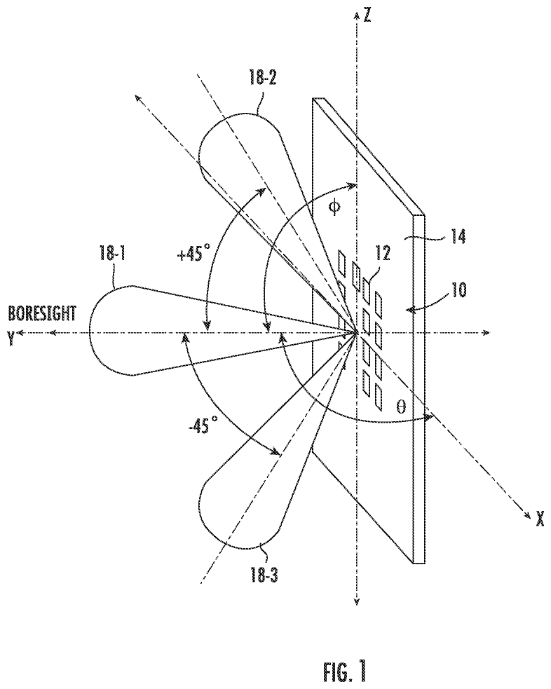

FIG. 1 is a schematic diagram illustrating the electronic beam steering capabilities of a conventional two-dimensional array of radiating elements when the antenna array is mounted on a wall.

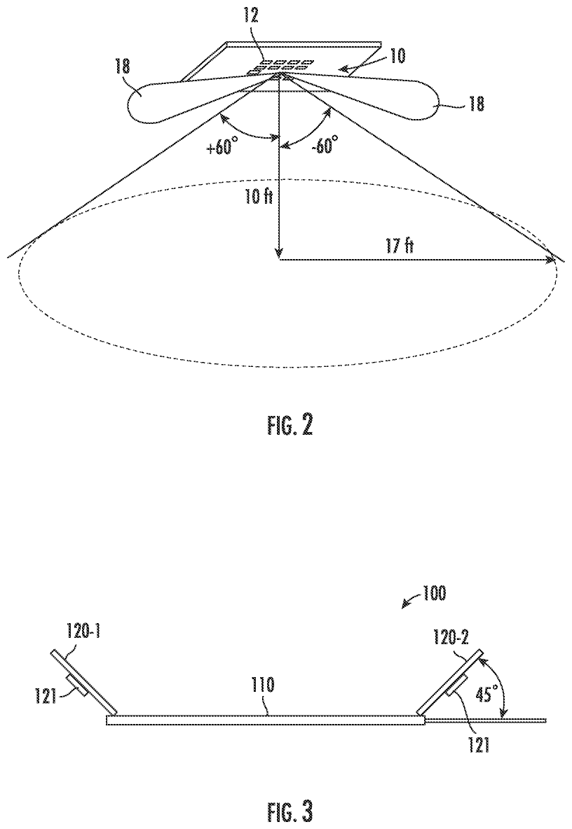

FIG. 2 is a schematic diagram illustrating the electronic beam steering capabilities of a conventional two-dimensional array of radiating elements when the antenna array is mounted on a ceiling.

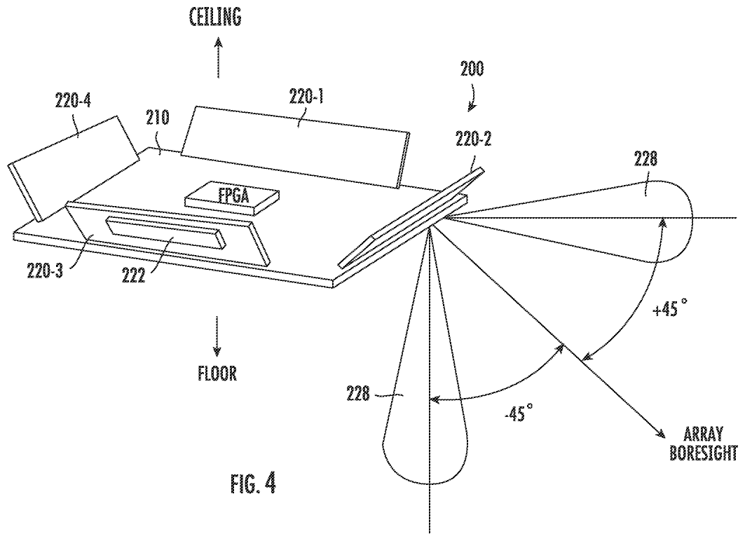

FIG. 3 is a schematic diagram of a radio node having an antenna array configuration according to embodiments of the present invention.

FIG. 4 is a schematic diagram of a radio node according to embodiments of the present invention that includes one base electronics printed circuit board and four antenna array modules.

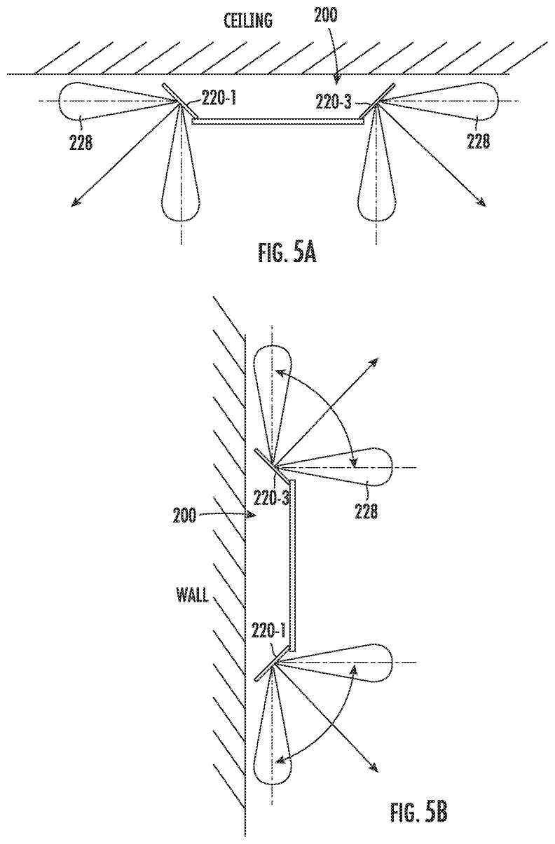

FIGS. 5A and 5B are schematic diagrams illustrating the radio node of FIG. 4 mounted in a ceiling mount configuration and a wall mount configuration, respectively.

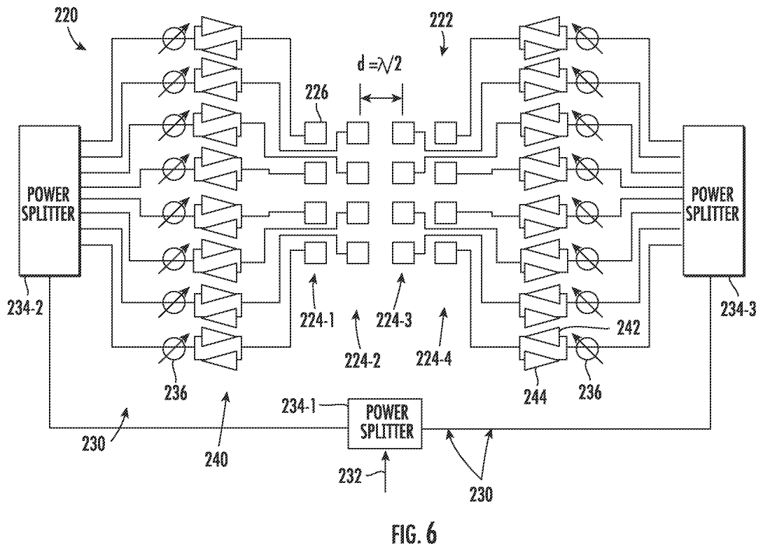

FIG. 6 is a schematic diagram of RF circuitry that may be included in each of the antenna array modules of the radio node of FIG. 4.

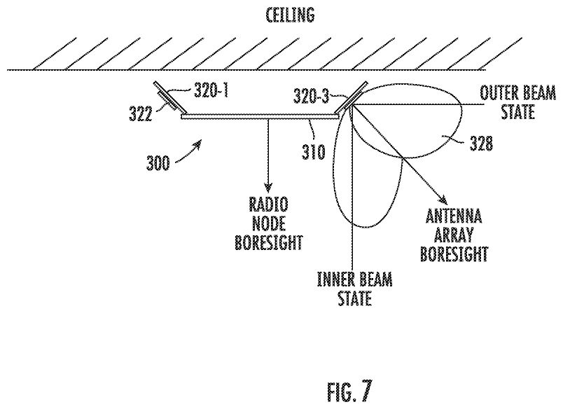

FIG. 7 is a schematic cross-sectional view of a radio node according to embodiments of the present invention that employs two-state antenna beam control in the elevation plane in conjunction with full electronic beam steering control in the azimuth plane, where the radio node is mounted in a ceiling mount configuration.

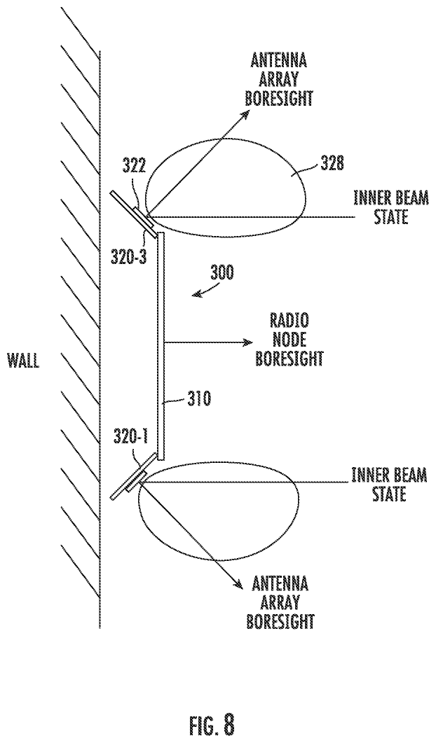

FIG. 8 is a schematic cross-sectional view of the radio node of FIG. 7 mounted in a wall mount configuration.

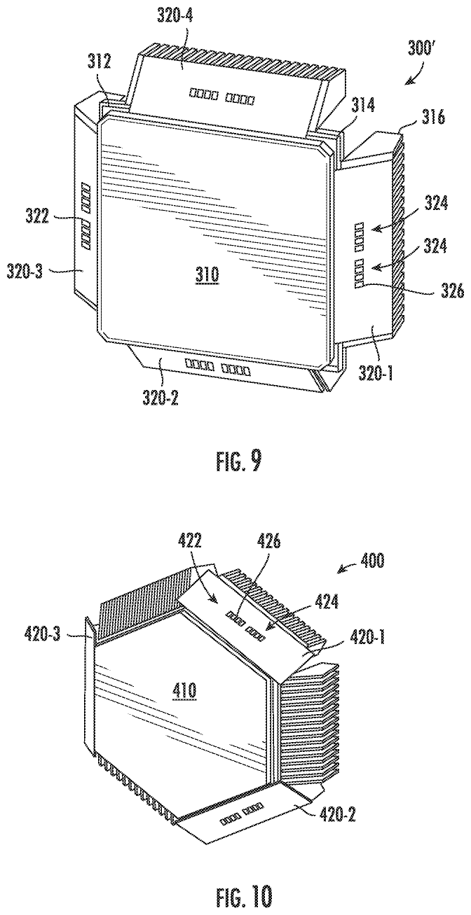

FIG. 9 is a schematic perspective view of a radio node according to embodiments of the present invention that includes a base electronics PCB combined with four antenna array modules.

FIG. 10 is a schematic perspective view of a radio node according to embodiments of the present invention that includes a base electronics PCB combined with three antenna array modules.

FIG. 11 is a schematic view of a column of radiating elements and an associated feed network that illustrates how the column of radiating elements may be configured to generate one of two different radiation patterns in the elevation plane in order to implement two-state beam steering control in the elevation plane.

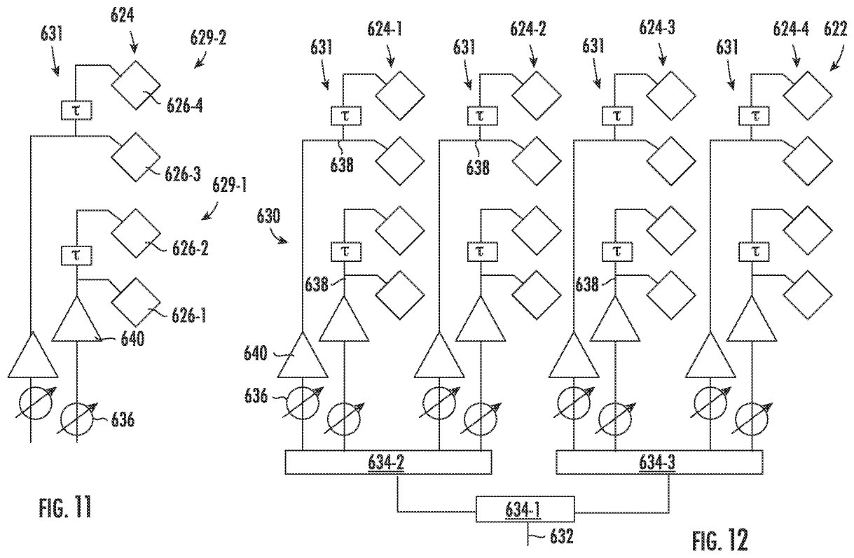

FIG. 12 is a schematic view of an antenna array that includes four of the columns of radiating elements of FIG. 11 and their associated column feed networks.

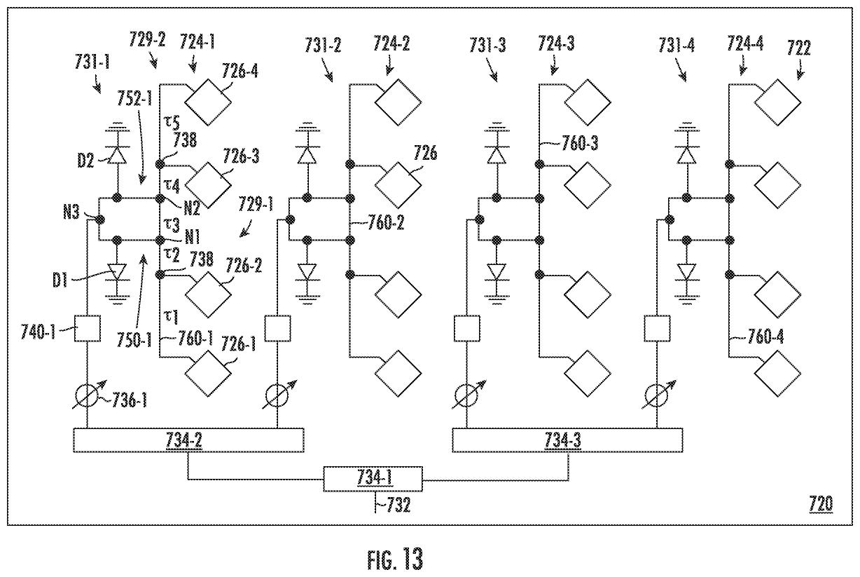

FIG. 13 is a schematic diagram that illustrates an example embodiment of an antenna array module according to embodiments of the present invention that implements two-state beam control in the elevation plane and full beam steering in the azimuth plane.

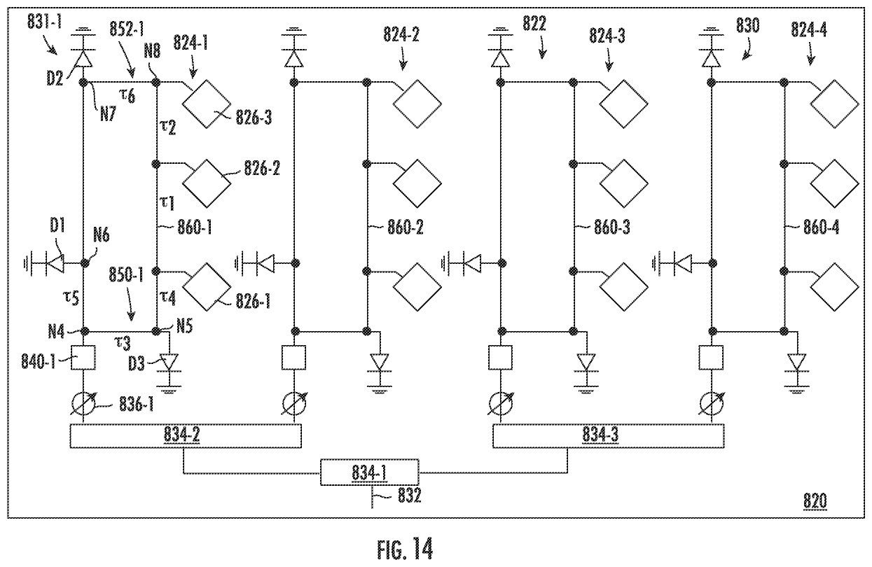

FIG. 14 is a schematic diagram that illustrates an example embodiment of an antenna array module according to further embodiments of the present invention that implements two-state beam control in the elevation plane and full beam steering in the azimuth plane.

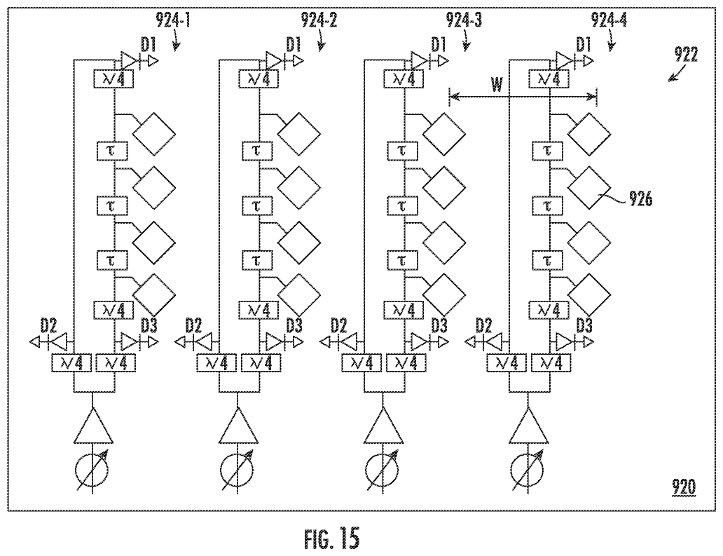

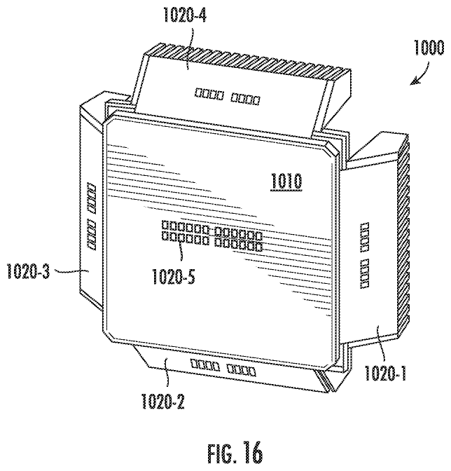

FIG. 15 is a schematic diagram that illustrates an antenna array module that is similar to antenna array of FIG. 14 except that it includes four radiating elements per column.

FIG. 16 is a schematic diagram of a radio node according to further embodiments of the present invention that includes an antenna array module that has a boresight pointing direction that is perpendicular to a plane define by a main electronics printed circuit board of the radio node.

Two-part reference numerals are used herein to identify like elements. When two-part reference numerals are used, the full reference numeral (e.g., antenna array module 220-2) may be used to refer to a specific instance of the element, while the first part of the reference numeral (e.g., the antenna array modules 220) may be used to refer to all of the elements collectively.

### DETAILED DESCRIPTION

Pursuant to embodiments of the present invention, radio nodes are provided that include one or more planar antenna arrays that can switch their electronic beam steering coverage characteristics depending on the mounting orientation of the radio node.

In some embodiments, radio nodes are provided that comprise RF circuitry and an antenna array that includes a plurality of columns of radiating elements. The antenna array is coupled to the RF circuitry, and is configured to have a discrete set of beam states in an elevation plane of the antenna array. A first subset of the discrete set of beam states is associated with the radio node being mounted in a wall mount configuration and a second subset of the discrete set of beam states is associated with radio node being mounted in a ceiling mount configuration. In some embodiments, the antenna array may be configured to have a total of two beam states in the elevation plane so that the first subset of the discrete set of beam states includes a single first beam state and the second subset of the discrete set of beam states includes a single second beam state. In other embodiments, the first and/or second subsets of the discrete set of beam states may have more than one beam state. In some embodiments, the radio node may be configured to automatically use the first subset of the discrete set of beam states when the radio node is mounted in the wall mount configuration and to automatically use the second subset of the discrete set of beam states when the radio node is mounted in the ceiling mount configuration.

In some embodiments, the radio node may further comprise a base electronics PCB, and the antenna array may be part of an antenna array module that is mounted on the base electronics PCB. In some cases, the radio node may include a plurality of antenna array modules that are mounted on the base electronics PCB, where each antenna array module includes a respective antenna array. In such embodiments, each antenna array may define a respective plane, and the antenna array modules may be mounted on the base electronics PCB so that the planes defined by the respective antenna arrays each extend at a respective angle that is between about 30° and about 60° (e.g., about 45°) with respect to a major surface of the base electronics PCB.

Pursuant to further embodiments of the present invention, radio nodes are provided that include an antenna array module that comprises an RF input, a power divider that is coupled to the RF input, and an antenna array that includes at least a first column of radiating elements and a second column of radiating elements. The antenna array module further includes a first feed line that connects to each of the radiating elements in the first column of radiating elements and a second feed line that connects to each of the radiating elements in the second column of radiating elements. A first output of the power divider is connected to the first feed line by a first path and a second path, and a second output of the power divider is connected to the second feed line by a third path and a fourth path. The first output of the power divider may be selectively connected to the first feed line by one of the first path and the second path, and the second output of the power divider may be selectively connected to the second feed line by one of the third path and the fourth path. Diodes such as PIN diodes may be used to selectively couple the first output of the power divider to one of the first and second paths and to selectively connect the second output of the power divider to one of the third and fourth paths.

In some embodiments, the first path connects to the first feed line at a first location and the second path connects to the first feed line at a second location that is different from the first location. For example, the first location may be spaced apart from the second location along the first feed line a distance that corresponds to a phase shift of between 45° and 135° (e.g., 90°) for an RF signal having a frequency that corresponds to a center frequency of the operating frequency band of the antenna array. In some embodiments, a top radiating element in the first column may connect to the first feed line at a third location, a bottom radiating element in the first column may connect to the first feed line at a fourth location, and the first location and the second location may both be between the third location and the fourth location.

Pursuant to still further embodiments of the present invention, radio nodes are provided that comprise an array of radiating elements that includes at least a first column of radiating elements, a first feed line that connects to each of the radiating elements in the first column, and a first phase weighting element that is selectively coupled to the first feed line via a first path and a second path. These radio nodes are configured to couple the first phase weighting element to the first feed line via the first path when the radio node is mounted in a wall mount configuration and is configured to couple the first phase weighting element to the first feed line via the second path when the radio node is mounted in a ceiling mount configuration.

Before discussing the radio nodes according to embodiments of the present invention in greater detail, a more detailed discussion of the difficulties in using planar arrays to provide full hemispheric coverage is helpful.

FIG. 1 is a schematic diagram illustrating the electronic beam steering capabilities of a conventional two-dimensional antenna array 10. The antenna array 10 includes a plurality of radiating elements 12 (depicted as square patch radiating elements in FIG. 1) that are arranged in rows and columns. The radiating elements 12 extend forwardly from a backplane 14 which may comprise, for example, a metal plate or layer that serves as a ground plane and reflector for the radiating elements 12.

An RF signal (e.g., a mmWave signal) may be passed from a radio (not shown) to the antenna array 10. The RF signal may be divided into a plurality of sub-components, and each sub-component of the RF signal may be passed to a respective sub-array of the radiating elements 12 for transmission, where each sub-array includes one or more radiating elements 12. The amplitudes and/or phases of the sub-components of the RF signal may be adjusted in order to shape the antenna beam 18 generated by the RF signal in a desired fashion and/or to change the pointing direction of the antenna beam 18 relative to the boresight pointing direction of the antenna array 10. The boresight pointing direction of antenna array 10 is labeled “Boresight” in FIG. 1 and is a direction perpendicular to the plane (the x-z plane) defined by the radiating elements 12 forming antenna array 10. Several antenna beams 18 are depicted in FIG. 1 to illustrate how an antenna beam can be electronically steered to point in different directions. In FIG. 1, only the main lobes of the antenna beams 18 are shown to simplify the figure. In the example of FIG. 1, antenna beam 18-1 “points” (i.e., has peak gain) in the boresight pointing direction of antenna array 10, while antenna beam 18-2 is electronically steered 45° in the elevation plane, and antenna beam 18-3 is electronically steered −45° in the elevation plane. Herein, the elevation plane refers to a plane that is perpendicular to the plane defined by the horizon that bisects the center of the antenna array 10, while the “azimuth plane” refers to a plane that is parallel to the plane defined by the horizon that bisects the center of the antenna array 10.

As shown in FIG. 1, by adjusting the relative phases of the sub-components of the RF signal, the generated antenna beam 18 may be electronically steered over two perpendicular axes, labeled x and z, relative to a “boresight” axis (labeled y) that is perpendicular to the plane of the antenna array 10. The boresight axis y corresponds to the boresight pointing direction of the antenna array 10. If the radiating elements 12 are spaced apart from each other (in both the x and z directions) by a distance of λ/2, where λ represents the wavelength corresponding to the center frequency of the RF signal that is to be transmitted, the antenna array 10 will typically have capability to steer the main lobe of the antenna beam 18 over the range of −45° to +45° relative to the boresight axis y (i.e., in both the azimuth and elevation planes). As the main lobe of the antenna beam 18 is steered away from the boresight direction, the directivity of the main lobe decreases and therefore the peak gain of the main lobe also decreases. Within a range of −45° to +45°, the amount of gain reduction, which is often referred to as the “electronic scan loss,” is typically within an acceptable range of 1 to 2 dB relative to an unscanned antenna beam 18 (i.e., with respect to antenna beam 18-1 in FIG. 1). However, as the antenna beam 18 is steered beyond +/−45° out to, for example, +/−60°, the electronic scan loss can increase to the range of 3 to 6 dB. As the antenna beam 18 is electronically steered beyond +/−60° out to +/−90°, the electronic scan loss can increase to well beyond 20 to 30 dB.

As noted above, the peak gain of the main lobe of an antenna beam 18 typically decreases as the main lobe is electronically scanned away from the boresight axis of the antenna array 10. One factor contributing to this reduction in gain is the fact that the individual radiating elements 12 that form the antenna array 10 exhibit different gain levels in different pointing directions. In particular, since an ideal isotropic element does not exist, every radiating element 12 has a non-uniform radiation pattern that results in increased gain in some directions and decreased gain in others. For example, a planar patch radiating element 12 mounted above a ground plane 14 has a relatively wide main lobe that exhibits peak gain in a direction that is directly perpendicular to the plane of the patch radiating element 12 and the ground plane 14 disposed behind the patch radiating element 12. The main lobe of the antenna beam 18 generated by the patch radiating element 12 typically has a 3 dB beamwidth that is approximately 90°; therefore at angles of approximately +/−45° the gain of the main lobe is 3 dB lower than the gain in the boresight pointing direction of the antenna array 10. These angles are cited as a representative example since it will be appreciated that the 3 dB beamwidth of a patch radiating element 12 can be more or less than 90° depending on how it is designed. Another important characteristic of a typical patch radiating element 12 is that it generates radiation patterns that generally have nulls at +/−90°. Therefore, a planar antenna array 10 of patch radiating elements 12 will naturally have difficulty in electronically steering the main lobe of the antenna beam 18 to angles that approach +/−90° as the individual radiating elements 12 in the antenna array 10 have virtually no gain at these extreme angles. As a result of these effects, a planar array may struggle to provide any significant gain at steep electronic steering angles that approach +/−90°.

If a radio node containing a planar antenna array 10 is mounted vertically (e.g., on a wall) as shown in FIG. 1, then the requirement for antenna gain as a function of electronic beam steering angle can largely be met using the electronic beam steering characteristics of a planar antenna array as described above, since the antenna array 10 can generate antenna beams having relatively high gain in the directions where the free space loss is the greatest. As an example, consider providing coverage to a square room that is 100 feet on each side with the antenna array for the radio node mounted in the center of one of the walls of the room. Under these conditions, the maximum required range at boresight is 100 feet and the maximum range at electronic steering angles of +/−90° is only 50 feet. The opposite corners of the room are at the greatest distance, corresponding to a distance of 112 feet at a beam steering angle of +/−26°. Thus the free space loss will be the largest when the antenna beam is electronically scanned at angles of between about +20° to +30° and between −20° to −30°. At these electronic scanning angles, the loss in gain is relatively small (e.g., 1-2 dB), and hence high gain levels are available to overcome the regions of the coverage area (here the room) where the free space loss will be the greatest (here the corners of the room at the greatest distance from the radio node). The array gain requirement decreases by about 6 dB relative to boresight as the electronic steering angle approaches +/−90° since the range at these angles (50 feet) is half of the range at boresight (100 feet).

In contrast, consider when the same antenna array 10 is mounted to a ceiling as shown in FIG. 2. At an example mounting height of 10 feet, a user at a 17 foot distance is at an electronic scanning angle of 60° relative to boresight, a user at a 57 foot distance is at an electronic scanning angle of 80°, and a user at a 200 feet distance is at an electronic scanning angle of 87°. For a cell coverage area having radius of 250 feet, simple mathematics can be used to demonstrate that for a group of users uniformly distributed over this coverage area, 99% of the users will be within the two angular ranges of −68° to −88° and +68° to +88°. Therefore, for a ceiling mount application, an antenna array 10 capable of only electronically steering an antenna beam over a range of −60° to +60° will not provide adequate coverage over the most critical angular beam steering range. In other words, a radio node in a ceiling mount installation providing coverage to a cell having a radius of 250 feet should have capability to electronically steer its generated antenna beam 18 over the two angular ranges of (1) −68° to −88° and (2)+68° to +88° in order to provide adequate coverage throughout the coverage area.

As the above example makes clear, the electronic scanning loss for a planar antenna array in a ceiling mount configuration is the opposite of what is desired. Within electronic scanning angles between −45° to +45°, a user is virtually directly underneath the radio node at a very short distance of 10 feet or less, and hence these users experience almost no free space loss and also experience almost no electronic scanning loss. As a result, the effective isotropic radiated power (EIRP) may be very high and may even need to be reduced to avoid any possible safety issues due to focused electromagnetic field strength. In contrast, for electronic scanning angles between −65° and −88° and between 65° and 88°, both the free space loss and the electronic scanning loss are high, and hence the radio node may provide poor coverage to users in these electronic scanning angle ranges. As noted above, as much as 99% of the coverage area for the radio node may be at large electronic scanning angles where the radio node will provide poor coverage.

As the above example makes clear, a radio node cannot easily support the coverage requirements for both ceiling mount and wall mount installations with a single planar antenna array. Due to the limitations in the angular beam steering range of a planar antenna array, a single planar antenna array cannot effectively meet the hemispheric coverage requirements of a radio node that can be mounted in either a ceiling or wall mount installation. If it is optimized for one installation, it will be sub-optimal for the other and therefore have coverage limitations.

The optimal configuration for a radio node that is configured to support both wall mount and ceiling mount configurations would be a radio node having an antenna array that exhibits virtually uniform antenna gain as the generated antenna beam is electronically scanned across both axes of the hemisphere, or involves a radio node having capability to switch its antenna beam steering coverage characteristics depending on how the radio node is mounted. Although some approaches have been proposed to address the hemispheric coverage requirement, these approaches often involved antenna arrays having a very large number of very closely spaced radiating elements, with each radiating element requiring individual phase weighting, or involve non-planar implementations, such as spherical or conformal arrays. Both of these approaches can be expensive to manufacture.

Pursuant to embodiments of the present invention, antenna arrays (and radio nodes including such antenna arrays) are provided that address the above-discussed multi-installation coverage issue in a way that has reduced impact on cost and manufacturability. The radio nodes according to certain embodiments of the present invention can switch their beam steering coverage characteristics depending on the mounting arrangement of the radio node. A radio node 100 having an antenna array configuration according to embodiments of the present invention is schematically illustrated in FIG. 3. As shown in FIG. 3, the radio node 100 includes a base electronics PCB 110 that has a plurality of individual antenna array modules 120 mounted thereon. Each antenna array module 120 may be mounted, for example, at a respective angle of about 45° as illustrated with respect to a plane defined by a major surface of the base electronics PCB 110, or at an angle of between about 25° and about 65° in other example embodiments. Each antenna array module 120 may include a two-dimensional antenna array that includes a plurality of radiating elements, and may also include various RF circuitry 121 such as power amplifiers, low noise amplifiers, filters, phase and/or amplitude weighting elements and antenna feed networks. The base electronics PCB 110 may include, for example, other signal processing circuitry, either analog or digital, to provide the main data interface to the radio, timing circuits, MAC or physical level signal processing, digital front-end circuitry, power management circuits, and distribution circuitry for passing transmit and receive signals between the circuitry on the base electronics PCB 110 and the antenna array modules 120. The number of antenna array modules 120 associated with, or attached to, the base electronics PCB 110 may be as few as one or could be multiple antenna array modules 120 such as two, three, four or any quantity that would be beneficial toward meeting desired performance requirements.

FIG. 4 is a schematic diagram of a radio node 200 according to embodiments of the present invention that includes a base electronics PCB 210 (which includes, among other things, a field programmable gate array or FPGA) combined with four antenna array modules 220-1 through 220-4. FIGS. 5A and 5B are schematic diagrams illustrating the radio node 200 of FIG. 4 mounted in a ceiling mount configuration and a wall mount configuration, respectively. As noted above, a planar antenna array such as the antenna arrays 222 included in each antenna array module 220 may electronically scan a generated antenna beam 228 over a range of −45° to +45° in both the azimuth and elevation planes with low (e.g., less than 1-2 dB) electronic scanning loss. As illustrated in FIG. 5A, when the antenna beams 228 generated by each of the antenna array modules 220 (only antenna array modules 220-1 and 220-3 are shown in FIG. 5A to simplify the view) are electronically steered over the range of −45° to +45° in the elevation plane (i.e., the range having a low electronic scanning loss), the pointing direction of the antenna beam 228 may extend anywhere from pointing downwardly at the floor (i.e., at a scanning angle of −45° in the elevation plane) to pointing at the walls (i.e., at a scanning angle of +45° in the elevation plane). While not shown in FIG. 5A, the antenna beams 228 generated by each of the antenna array modules 220 can likewise be electronically steered over a range of −45° to +45° azimuth plane. It can easily be envisioned from FIGS. 4 and 5A that the radio node 200, when mounted in a ceiling mount configuration, may generate antenna beams 228 that cover the entire coverage area without the need to electronically scan any of the antenna beams 228 more than between −45° to +45° in the azimuth and elevation planes.

As illustrated in FIG. 5B (which is a view looking downwardly from the ceiling toward the floor), when the radio node 200 is mounted in a wall mount configuration, scanning each antenna beam 228 between −45° and +45° in the azimuth plane acts to steer the antenna beams 228 from pointing anywhere between a side wall and the opposed wall. Again, it can be seen that the radio node 200, when mounted in a wall mount configuration, may generate antenna beams 228 that cover the entire coverage area without the need to electronically scan any of the antenna beams 228 more than between −45° to +45° in the azimuth and elevation planes.

Thus, by providing four antenna array modules 220 in the configuration shown in FIGS. 4-5B, radio node 200 can achieve full hemispherical coverage with a high level of beamforming gain over the full hemisphere. Thus, radio node 200 may provide good performance in both ceiling and wall mount installations.

FIG. 6 is a schematic diagram of certain RF circuitry that may be included in each of the antenna array modules 220 in the radio node 200 of FIGS. 4-5B. As shown in FIG. 6, the antenna array module 220 includes an antenna array 222 that comprises a plurality of radiating elements 226. The antenna array 222 includes a total of sixteen radiating elements 226 that are arranged in four rows and four columns 224, although the antenna array 222 may include other numbers of rows and/or columns 224 in other embodiments. The antenna array module 220 further includes an antenna feed network 230 that has an RF input port 232 and one or more power dividers 234. In the example embodiment shown, the power dividers 234 split RF signals that are input at RF input port 232 into sixteen sub-components. In the depicted embodiment, three power dividers 234 are provided, namely a 1×2 power divider 234-1 and a pair of 1×8 power dividers 234-2, 234-3.

The sixteen outputs of the 1×8 power dividers 234-2, 234-3 are coupled to sixteen respective phase and/or amplitude weighting elements 236, that are in turn coupled to sixteen amplifier circuits 240. Each amplifier circuit 240 includes a high power amplifier 242 and a low noise amplifier 244 along with switching circuitry (e.g., RF switches, circulators or the like) that pass transmit path RF signals to the power amplifiers 242 and receive path RF signals to the low noise amplifiers 244. The output of each amplifier circuit 240 is coupled to a respective one of the radiating elements 226. The columns 224 of radiating elements 226 are shown as being spaced apart by λ/2, which is referred to as the “element spacing.” It will be appreciated that a λ/2 element spacing is shown as a typical example. The element spacing may be selected based on a desired electronic beam steering range for the radio node 200 and limits on the sidelobe or grating lobe performance. In example embodiments, the element spacing may be between 0.4×λ and 0.6×λ, or more broadly between 0.3×λ and 0.7×λ. Therefore, although 0.5×λ is shown in FIG. 6 (and with respect to other antenna arrays discussed below), it will be appreciated that the antenna array modules included in radio nodes according to embodiments of the present this invention may have any appropriate element spacing.

As can be seen from FIG. 6, each antenna array module 220 has full electronic beam steering capability, since independent phase weighting and optional amplitude weighting are provided for each radiating element 226. Assuming that an electronic scan loss should be limited to be less than, for example, about 2 dB, each antenna array module 220 may electronically scan an antenna beam 228 over the range of −45° to +45° in both the azimuth and elevation planes. While this approach provides good coverage over the hemispheric field of view, it may not be necessary or cost effective to provide full beam steering capability in the elevation plane.

Pursuant to further embodiments of the present invention, radio nodes 300 are provided having antenna array modules 320 that have antenna arrays 322 that implement two-state antenna beam control in the elevation plane in conjunction with full electronic beam steering control in the azimuth plane. Similar to the radio nodes discussed above, radio node 300 includes a main electronics PCB 310 as well as one or more antenna array modules 320. The capability of radio node 300 to provide full electronic beam steering control in the azimuth plane allows the main lobe of each antenna beam 328 to be electronically scanned to any angle in the azimuth plane. The two-state antenna beam control in the elevation plane means that the main lobe of the antenna beam can only be pointed in one of two directions in the elevation plane, which are referred to herein as an outer beam state and an inner beam state. This is shown schematically in FIG. 7. Both beam states produce antenna beams 328 that have a relatively wide beamwidth in the elevation plane.

In the outer beam state condition, the peak of the main lobe of the antenna beam 328 generated by each array 322 is directed toward +45° relative to the boresight pointing direction of the antenna array module 320 that generates the antenna beam 328. Thus, when the radio node 300 is mounted on a ceiling, the peak of the main lobe of each antenna beam 328 points toward +90° relative to the “boresight” pointing direction of the radio node 300, since the antenna array module 320 is mounted at an angle of 45° relative to the base electronics PCB 310. In some embodiments, the shape of the antenna beam 328 in the elevation plane may be tailored to provide a null-filled pattern from its peak at +45° across its full range to −45° relative to the boresight pointing direction of the antenna array module 320. The outer beam state condition would mainly support the ceiling mount applications, since the peak of the main lobe would be directed toward the horizon where the highest antenna gain would be needed. Each antenna array module 320 (there may be four such antenna array modules 320 in this embodiment, similar to that shown in FIG. 4) would cover the full elevation range from the boresight pointing direction of the radio node 300 to the horizon with a single antenna beam state in the elevation plane, with the peak of the antenna beam 328 positioned near the horizon.

For the inner beam state condition, the peak of the main lobe of the antenna beam 328 would be directed toward −45° relative to the boresight of the antenna array module 320. This is illustrated in FIG. 8. Since the antenna array module 320 is mounted at an angle of 45° relative to the base electronics PCB 310, the peak of the main lobe points in the same direction as the boresight pointing direction of the radio node 300. The elevation pattern may be tailored to provide a null-filled pattern from its peak at −45° across its full range to +45° relative to the boresight pointing direction of the antenna array module 320. This inner beam state condition would mainly support wall mount applications since the peak of the main lobe of each antenna beam 328 would be directed toward the horizon where the highest antenna gain would be needed when wall mounted. The antenna array module 320 would cover the full elevation range from the boresight pointing direction of the radio node 300 to the floor with a single beam state in the elevation plane which has a peak of the antenna beam 328 positioned near the horizon.

FIG. 9 is a schematic perspective view of a radio node 300′ that may be identical to the radio node 300 of FIGS. 7 and 8, except that each antenna array 322 included in the antenna array modules 320 of radio node 300′ includes twelve columns 324 of radiating elements 326 that have two radiating elements 326 per column 324. As shown in FIG. 9, the radio node 300′ includes four antenna array modules 320, where each antenna array module 320 is connected to a base electronics PCB 310. The base electronics PCB 310 and/or the four antenna array modules 320 may be mounted to a heat sink 312. The heat sink 312 may comprise a base plate 314 and/or heat fins 316 that help remove heat from the radio node 300 and, in particular, heat generated by active circuits on the base electronics PCB 310 and/or the antenna array modules 320. The four antenna array modules 320 may be mounted at angles of about 45° relative to the base electronics PCB 310. The four antenna array modules 320 may be electrically connected to the base electronics PCB 310 through connections that provide DC power, control signals, and RF and intermediate frequency (“IF”) signals. To achieve full hemispheric beam steering coverage, each antenna array module 320 may provide two-state electronic beam steering in the elevation plane (with the two different antenna beams in the elevation plane pointed at angles of −45° and +45° with respect to the boresight pointing direction of each antenna array 322) coupled with full electronic beam steering over a range of −45° to +45° in the azimuth plane. Any of the radio nodes disclosed herein, including radio nodes 100, 200 that are discussed above, may take the form shown in FIG. 9.

While FIG. 9 illustrates a radio node 300′ that has four antenna array modules 320 that are connected to the base electronics PCB 310, in other embodiments of the present invention, radio nodes may include other numbers of antenna array modules. For example, some radio nodes according to embodiments of the present invention may include a single antenna array module that is mounted at an optimal angle relative to a base electronics PCB. Other embodiments may include other quantities of antenna array modules such as two, three, five, six or more mounted to a single base electronics PCB.

The quantity of antenna array modules that are attached or otherwise associated with a base electronics PCB may be selected based on the application. FIG. 10 is a schematic perspective view of a radio node 400 that includes a base electronics PCB 410 combined with three antenna array modules 420, each of which includes an antenna array 422 that includes a plurality of columns 424 of radiating elements 426. As shown in FIG. 10, the three antenna array modules 420-1 through 420-3 may be mounted at 45° angles relative to the base electronics PCB 410. To achieve full hemispheric beam steering coverage, each antenna array module 420 provides beam steering over a range of −60° to +60° in the azimuth plane.

The advantage of employing two-state beam control in the elevation plane as compared to an array having a large (or unlimited) quantity of possible beam states in the elevation plane is that antenna array modules that implement two-state beam control in the elevation plane may have significantly reduced cost, complexity, and power consumption (with respect to the front-end electronics on the base electronics PCB). FIG. 11 is a schematic view of a column 624 of radiating elements 626 and an associated column feed network 631 that illustrates how the column 624 may be configured to generate one of two different antenna beams in the elevation plane in order to implement two-state beam steering control in the elevation plane.

As shown in FIG. 11, the column 624 includes four radiating elements 626 that are divided into first and second subarrays 629-1, 629-2, with the radiating elements 626-1 and 626-2 in sub-array 629-1, and radiating elements 626-3 and 626-4 in sub-array 629-2. The radiating elements 626 within each subarray 629 have a fixed time difference, or delay, τ, therebetween. In other words, an RF signal that feeds a given one of the sub-arrays 629 is split into two sub-components, and the first sub-component reaches the first radiating element 626 of the sub-array 629 at a time τ before the second sub-component reaches the second radiating element 626 of the sub-array 629. As shown in FIG. 11, since two radiating elements 626 are coupled to each phase weighting element 636, only two independent phase weighting elements 636 are used to steer the antenna beam that is generated by the column 624 in the elevation plane, versus the four independent phase weighting elements 636 that are required when full elevation beam steering is provided in the elevation plane, as is the case with the radio node 200 discussed above with reference to FIG. 6. By setting the fixed time delay (τ) to create an electrical phase offset of between 125° and 180° between the sub-components of the RF signal that are fed to the two radiating elements 626 of each subarray 629, it is possible to implement the electronic beam steering in the elevation plane using a reduced number of phase weighting circuits 636, but with less control as to the shape and the pointing direction of the generated antenna beam in the elevation plane.

FIG. 12 is a schematic view of an antenna array 622 that includes four of the columns 624 of radiating elements 626 of FIG. 11 and their associated column feed networks 631. As can be seen, each column 624 in FIG. 12 may be identical to the column 624 shown in FIG. 11. The four columns 624 are fed by a combined feed network 630 that includes the four individual column feed networks 631 that feed each respective column 624, as well as an RF input port 632 and three power dividers 634-1 through 634-3. The first power divider 634-1 is a 1×2 power divider that may evenly split RF signals received from the RF input port 632. Power dividers 634-2 and 634-3 are each 1×4 power dividers, with each output of these power dividers coupled to a respective one of eight phase and/or amplitude weighting elements 636. Each phase and/or amplitude weighting element 636 is coupled to a respective amplifier circuit 640. While not shown, each amplifier circuit 640 may include a high power amplifier and a low noise amplifier along with switching circuitry in the same manner as the corresponding amplifier circuits 240 shown in FIG. 6. The output of each amplifier circuit 640 is coupled to a pair of the radiating elements 626 through respective 1×2 power dividers 638.

Since each column 624 of antenna array 622 is fed an independently phase-controlled sub-component of any RF signal input at RF input 632, the antenna array 622 will exhibit unlimited phase control in the azimuth plane, as independent phase weighting may be applied to the radiating elements 626 in each of the columns 624. The rows of the antenna array 622, however, are not independently fed, and instead the top two rows are fed by common inputs and the bottom two rows are fed by common inputs. As such, the beam steering capability in the elevation plane is reduced since the beam steering in the elevation plane may be between a few discrete states such as the inner and outer states described previously.

FIG. 13 is a schematic diagram that illustrates an example embodiment of an antenna array module 720 according to embodiments of the present invention that implements pure two-state beam control in the elevation plane and full beam steering capability in the azimuth plane. As shown in FIG. 13, the antenna array module 720 includes an antenna array 722. The antenna array 722 includes a plurality of columns 724 of radiating elements 726. Each column 724 includes an associated column feed network 731 that feeds the sub-components of an RF signal to the respective column 724. In the illustrated embodiment the antenna array 722 includes a total of four columns 724 and column feed networks 731, and each column 724 includes four radiating elements 726. It will be appreciated however, that different numbers of columns 724 and/or different numbers of radiating elements 726 per column 724 may be employed in other embodiments. All of the columns 724 and column feed networks 731 may be identical, so the discussion below focuses on the first column 724-1 and the first column feed network 731-1.

The antenna array module 720 may be part of a radio node (not shown). For example, the antenna array module 720 may be one of four antenna array modules 720 that are coupled to a base electronics PCB in the manner shown in FIG. 9 above. RF circuitry may be provided for each antenna array module 720 that may generate RF signals that are passed to the antenna arrays 722 for transmission. The RF circuitry may be on the base electronics PCB and/or the antenna array module 720 and/or in other locations. For example, RF circuitry in the form of phase and/or amplitude weighting elements 736 may be provided on each antenna array module 720 in some embodiments.

As is further shown in FIG. 13, antenna array 722 includes four feed lines 760-1 through 760-4. Each feed line 760 connects to the four radiating elements 726 in a respective one of the columns 724, and is used to pass RF signals between the radiating elements 726 in each column 724 and the associated column feed network 731. Each feed line 760 may comprise, for example, a microstrip transmission line or some other form of RF transmission line. As will be discussed in greater detail below, each column feed network 731 connects to a central portion of its associated feed line 760 that is between the locations where the top and bottom radiating elements 726 in the column 724 connect to the feed line 760.

As is further shown in FIG. 13, in this embodiment, fixed electrical delays are provided between the radiating elements 726 in each column 724. In particular, a fixed electrical delay τ₁ is provided between radiating elements 726-1 and 726-2, a fixed electrical delay τ₂+τ₃+τ₄ is provided between radiating elements 726-2 and 726-3, and a fixed electrical delay τ₅ is provided between radiating elements 726-3 and 726-4. This allows each column 724 to be fed by a single phase and/or amplitude weighting element 736. Each column 724 is divided into two sub-arrays 729, namely a lower sub-array 729-1 that includes radiating elements 726-1 and 726-2 and an upper sub-array 729-2 that includes radiating elements 726-3 and 726-4. Sub-array power dividers 738 split RF signals that are fed to each sub-array 729 into two sub-components that are fed to the two radiating elements 726 of each sub-array 729. In example embodiments, the fixed electrical delays τ₁ and τ₅ may each correspond to a phase delay of 180°, although embodiments of the present invention are not limited thereto. For example, depending upon the response desired in the elevation plane, the fixed electrical delays τ₁ and τ₅ may each correspond to a phase delay of between 125° and 180° electrical phase.

A feed network 730 is used to feed the antenna array 722. The feed network 730 includes the four column feed networks 731 and three 1×2 power dividers 734-1 through 734-3 that split RF signals input at an RF input port 732 into four equal sub-components that feed the four respective columns 724. As shown with reference to column 724-1, a first output of power divider 734-2 is coupled to a phase and/or amplitude weighting element 736-1. The phase and/or amplitude weighting element 736-1 may independently adjust the phase and/or amplitude of RF signals input thereto. Notably, a single phase and/or amplitude weighting element 736 is coupled to each column 724. Thus, the four-column, four row antenna array 722 requires only one quarter (25%) of the phase and/or amplitude weighting elements that are included in the same-sized antenna array 222 of FIG. 6. Since each column 724 includes a phase and/or amplitude weighting element 736, the relative amplitudes and/or phases of the sub-components of the RF signal that are fed to each column 724 may be independently adjusted, allowing for full electronic beam steering in the azimuth plane. The output of phase and/or amplitude weighting element 736-1 is coupled to a power amplifier circuit 740-1. The output of the power amplifier circuit 740-1 is coupled to a node N3.

The RF signals fed to node N3 may be coupled to the feed line 760-1 at either a first location or a second location. In particular, a lower path 750-1 connects node N3 to a first location (node N1) along the feed line 760-1, and an upper path 752-1 connects node N3 to a second location (node N2) along the feed line 760-1. A fixed electrical delay of τ₂ is provided between the first location (node N1) and the closest radiating element 726-2 in the lower sub-array 729-1 and a fixed electrical delay of τ₄, which may be identical to τ₂, is provided between the second location (node N2) and the closest radiating element 726-3 in the upper sub-array 729-2. Physical layout considerations will determine the values of τ₂ and τ₄, but a value corresponding to a phase delay of 90° allows for quarter-wave matching at the sub-array power dividers 738. Another feature of this approach is a fixed delay τ₃ between the two sub-arrays 729-1, 729-2, which results from the fact that the first and second locations (nodes N1, N2) are spaced apart from each other. In example embodiments, the fixed delay τ₃ may correspond to a phase delay of 90° so as to steer the peak of the antenna beam in the elevation plane to either −45° or +45° (depending on whether the inner beam or outer beam is selected). However, depending upon the elevation response desired, the delay τ₃ may be set to correspond to a phase delay of between 0° and 180° in other example embodiments. To control the setting of the elevation beam state, a pair of PIN diodes D1, D2 are provided, each of which may be biased to be in either an ON state or an OFF state. Each diode D1, D2 may be biased ON by applying a DC current thereto. This DC current is typically within the range of 10 to 20 milliamps. Each diode D1, D2 may be biased OFF by removing the DC current. When biased ON, the diodes D1, D2 are in a very low impedance state. When biased OFF, the diodes D1, D2 are in a very high impedance state. Diode D1 is positioned a quarter wavelength from node N3 and a quarter wavelength from node N1, and diode D2 is positioned a quarter wavelength from node N2 and a quarter wavelength from node N3.

Each column 724 in antenna array 722 may receive an independent phase weighting from its associated phase and/or amplitude weighting element 736. As a result, the antenna array 722 has a full electronic beam steering capability in the azimuth plane. In the elevation plane, the beam steering is limited to two states, namely a first state that is optimized for the ceiling mount application and a second state that is optimized for the wall mount application. This approach may meet the objectives for beam steering while dramatically reducing the number of independent phase and/or amplitude weighting elements 736 needed, as discussed above.

Focusing again on column 724-1, to scan the antenna beam to −45° in the elevation plane, diode D2 is biased to be in its OFF state. This places diode D2 in a high impedance state and allows RF energy to pass to column 724-1 through the upper path 752-1 that extends between Nodes N3 and N2. At the same time, diode D1 is biased ON. This creates an effective short circuit to ground, where the connection to ground is at a quarter wavelength from node N3 and a quarter wavelength from node N1. Node N3 is the point where the output of the power amplifier circuit 740-1 can travel to either the upper path 752-1 or the lower path 750-1. The short circuit at this point in the lower path 750-1 appears as an open circuit at both ends of the lower path 750-1 (i.e., at nodes N3 and N1). The effective open circuit prevents RF energy from passing to the lower path 750-1 and prevents the lower path 750-1 from loading either the output of the power amplifier circuit 740-1 or the feed line 760-1. This effectively allows column 724-1 to be fed from node N2, with RF feed signals being divided into two sub-components at node N2 that are fed to the respective upper and lower sub-arrays 729-1, 729-2. The sub-component fed to the lower sub-array 729-1 is electrically delayed by the amount τ₃ with respect to the sub-component fed to the upper sub-array 729-2. The effect of this delay τ₃ is to steer the generated antenna beam in the −45° direction in the elevation plane.

Conversely, to scan the beam to +45°, diode D1 is biased OFF. This places diode D1 in a high impedance state and allows RF energy to pass to column 724-1 through the lower path 750-1. At the same time, diode D2 is biased ON. This creates an effective short circuit to ground, where the connection to ground is at a quarter wavelength from node N3 and a quarter wavelength from node N2. The short circuit at this point in the upper path 752-1 appears as an open circuit at both ends of the upper path 752-1. The effective open circuit prevents RF energy from passing through the upper path 752-1 and prevents the upper path 752-1 from loading either the output of the power amplifier circuit 740-1 or the feed line 760-1. This effectively allows column 724-1 to be fed from node N1, with RF feed signals being divided into two sub-components at node N1 that are fed to the respective upper and lower sub-arrays 729-1, 729-2. The sub-component fed to the upper sub-array 729-2 is electrically delayed by the amount τ₃ with respect to the sub-component fed to the lower sub-array 729-1. The effect of this delay is to steer the generated antenna beam in the +45° direction in the elevation plane.

In some embodiments, the power dividers 738 that split the RF energy between the two radiating elements 726 of each sub-array 729 may be unequal power dividers to provide an amplitude taper to each sub-array 729. An amplitude taper with less power on the outer two radiating elements 726-1, 726-4 in column 724-1 as compared to the inner two radiating elements 726-2, 726-3 provides null fill in the elevation pattern to improve the gain in the boresight pointing direction of the antenna array 722 when the generated antenna beam is electronically steered to either the +45° or −45° directions in the elevation plane. For example, a 3 dB edge taper (i.e., power fed to each outer radiating element 726 in column 724 is half the power fed to each inner radiating element 726 in column 724) provides about 12 dB null fill.

FIG. 14 is a schematic diagram that illustrates an example embodiment of an antenna array module 820 according to further embodiments of the present invention that implements two-state beam control in the elevation plane and full beam steering capability in the azimuth plane. The antenna array module 820 includes an antenna array 822. The antenna array 822 includes four columns 824 of radiating elements 826, where each column 824 includes three radiating elements 826 each. Each column 824 includes an associated column feed network 831 that feeds the sub-components of an RF signal to the respective columns 824. All of the columns 824 and column feed networks 831 may be identical, so the discussion below focuses on the first column 824-1 and the first column feed network 831-1.

Antenna array 822 includes four feed lines 860-1 through 860-4. Each feed line 860 connects to the three radiating elements 826 in a respective one of the columns 824, and is used to pass RF signals between the radiating elements 826 in each column 824 and the associated column feed network 831. Fixed electrical delays are provided between the radiating elements 826 in each column 824. In particular, a fixed electrical delay τ₁ is provided between radiating elements 826-1 and 826-2, and a fixed electrical delay τ₂ is provided between radiating elements 826-2 and 826-3. This allows each column 824 to be fed by a single phase and/or amplitude weighting element 836.

A feed network 830 is used to feed the antenna array 822. The feed network 830 includes the four column feed networks 831 and three 1×2 power dividers 834-1 through 834-3 that split RF signals input at an RF input port 832 into four equal sub-components that feed the four respective columns 824. As shown with reference to column 824-1, a first output of power divider 834-2 is coupled to a phase and/or amplitude weighting element 836-1. Since each column 824 includes a phase and/or amplitude weighting element 836, the relative amplitudes and/or phases of the sub-components of the RF signal that are fed to each column 824 may be independently adjusted, allowing for full electronic beam steering in the azimuth plane. In the elevation plane, the beam steering is limited to two states, namely a first state that is optimized for the ceiling mount application and a second state that is optimized for the wall mount application.

The output of phase and/or amplitude weighting element 836-1 is coupled to a power amplifier circuit 840-1. The output of the power amplifier circuit 840-1 is coupled to a node N4. where RF signals may pass either to a lower path 850-1 or to an upper path 852-1.

The lower path 850-1 extends from node N4 to a node N5. A fixed electrical delay of τ₃ is provided between the node N4 and node N5. The fixed delay τ₃ may be equal to about 90°, although embodiments of the present invention are not limited thereto. A fixed electrical delay of τ₄ is provided between the node N5 and the feed line for radiating element 826-1. The fixed delay τ₄ may also be equal to about 90°, although embodiments of the present invention are not limited thereto.

The primary difference between antenna array 822 and antenna array 722 (FIG. 13) is that antenna array 822 is a serial end-fed antenna array that is fed either from one end or the other. Similar to the antenna array 722, the routing of the RF signal by the feed network 830 of array 822 is controlled by appropriately biasing PIN diodes, although each column feed network 831-1 includes three PIN diodes D1, D2, D3 as opposed to the two PIN diodes D1, D2 included in each column feed network 731 (FIG. 13).

A node N6 is provided along the upper path 852-1. In example embodiments, node N6 may be located at a fixed delay of τ₅ from node N4. The fixed delay τ₅ may be equal to about 90° in example embodiments. Diode D1 is connected to node N6. Diode D2 is coupled to another node N7 that is provided along the upper path 852-1. Node N7 may be positioned a fixed delay τ₆ before a node N8 that corresponds to the top of feed line 860-1. The fixed delay τ₆ may be equal to about 90° in example embodiments.

Focusing on column feed network 831-1 in FIG. 14, to scan the generated antenna beam to −45° in the elevation plane, diodes D1 and D2 are both biased OFF. This places diodes D1 and D2 in their high impedance states and allows RF energy to pass to column 824 through the upper path 852-1. At the same time, diode D3 is biased ON. This creates an effective short circuit to ground, where the connection to ground is at a quarter wavelength from node N4, which is the point where the output of the power amplifier circuit 840-1 can travel to either the lower path 850-1 or the upper path 852-1. The short circuit at this point in the lower path 850-1 appears as an open circuit at both ends of the lower path 850-1. The effective open circuit prevents RF energy from passing through the lower path 850-1 and prevents the lower path 850-1 from loading either the output of the power amplifier circuit 840-1 or the feed line 860-1. This effectively allows column 824-1 to be fed from node N8, which corresponds to feeding column 824-1 from the top end. The fixed electrical delays of τ₁ and τ₂ (which may be, for example, approximately 150°) between adjacent radiating elements 826 in column 824-1 cause the antenna beam to be steered in the −45° direction in the elevation plane.

Conversely, to scan the antenna beam in the +45° direction in the elevation plane, diode D3 is biased OFF. This places diode D3 in a high impedance state and allows RF energy to pass to the column 824-1 through the lower path 850-1. At the same time, diodes D1 and D2 are biased ON. This creates a pair of short circuits to ground at both ends of the upper path 852-1. The effective open circuit presented by the upper path 852-1 prevents RF energy from passing through this path and prevents this path from loading either the output of the power amplifier circuit or the feed line. This effectively allows the column 824-1 to be fed from the bottom end such that the fixed electrical delays of τ₁ and τ₂ between adjacent radiating elements 826 in the column 824-1 causes the antenna beam to be steered in the +45° direction in the elevation plane.

While FIG. 14 illustrates a two-beam state elevation control end-fed serial array approach using columns 824 that include three radiating elements 826, the number of radiating elements 826 can be extended to any practical quantity such as four, five, six or more or could be as few as two radiating elements. FIG. 15 is a schematic diagram that illustrates an antenna array 922 that is identical to antenna array 822 of FIG. 14, except that antenna array 922 includes four radiating elements 926 per column 924. In FIG. 15, the fixed delay between adjacent radiating elements may be the same value (τ) and each of the other fixed delays may be set to 90° (i.e., a quarter of a wavelength). The number of radiating elements 926 included in each column 924 of the antenna array 922 is dependent on the profile of the elevation beamwidth that is targeted to meet the coverage requirements of the associated radio node. An antenna array having columns with three radiating elements each provides an elevation beamwidth that is well suited for covering a large portion of a +90° sector.

One disadvantage of the antenna arrays 822, 922 of FIGS. 14-15 that employ end-fed columns is that the power split ratio at each location where a radiating element feed connects to the feed line for each column of radiating elements should be managed. In a typical end-fed linear serial array, the power split ratio at each radiating element feed is scaled by managing the feed line impedances to provide effectively either equal power into each radiating element or a tapered distribution of power. When the RF energy is always fed from only one end of the column, this control of the distribution is possible. But the distribution of power to each radiating element will not be the same when the column is fed from the opposite end. For example, if equal power distribution to each radiating element 826 of the antenna array 822 of FIG. 14 is desired and each column 824 in the antenna array 822 is fed from node N5 (the lower paths 850), then the junction where the first radiating element 826-1 in column 824-1 is fed from the feed line 860 for the column 824 may be designed for a power split of a 1:2 split ratio and the next junction may be designed for a 1:1 split ratio. These ratios would deliver ⅓ of the RF energy to each of the three radiating elements 826. Yet when the columns 824 of antenna array 822 are fed from node N8 (the upper paths 852), then the radiating element feed impedances would not be correctly set to provide the same uniform distribution of power. Therefore, designing the antenna array to provide elevation patterns for the two beam states that have ideal patterns that are mirror images may be more difficult. For the two-state end-fed array, it is likely best to design each radiating element junction to provide the same power split ratio.

While the radio nodes discussed above primarily have antenna array modules that are positioned at an angle of about 45° with respect to a plane defined by the base electronics PCB of the radio node, it will be appreciated that embodiments of the present invention are not limited thereto. Instead, the antenna array modules may be positioned at any appropriate angle with respect to the plane defined by the base electronics PCB of the radio node. In example embodiments, at least some of the antenna array modules may be positioned at angles of between about 30° and about 60°. The best angle may be a function of the application. For example, with large coverage areas, larger angles may be better when the radio node is mounted on a ceiling, as the larger angle will best provide service to the outer reaches of the coverage area. For wall mount applications, smaller angles may generally be preferred. In some embodiments, the antenna array modules may be mounted to the base electronics PCB using hinges so that the angle defined by each antenna array module with respect to the base electronics PCB may be set by an installer.

FIG. 16 is a schematic diagram of a radio node 1000 according to further embodiments of the present invention that includes an additional antenna array module 1020-5 that has a boresight pointing direction that is perpendicular to a plane define by a main electronics printed circuit board 1010 of the radio node 1000. As noted above, in some applications—such as ceiling mount applications in large rooms—it may be desirable to increase the angle defined by at least some of the antenna array modules and the base electronics PCB. However, increasing the angle may degrade performance if the same radio node is used in a wall mount configuration, as coverage may degrade in the direction of the wall opposite the wall on which the radio node is mounted and/or to the far corners of the room in which the radio node is installed. As shown in FIG. 16, a radio node 1000 may be provided that is similar to radio node 300 discussed above, except that radio node 1000 further includes an additional antenna array module 1020-5 that is mounted on the base electronics PCB 1010. The additional antenna array module 1020-5 may have a boresight pointing direction that is coincident with the boresight pointing direction of the radio node 1000, and hence may have high gain in the direction toward the far wall when the radio node 1000 is mounted in a wall mount configuration. In some embodiments, the additional antenna array module 1020-5 may have full beam scanning capability in the azimuth plane, which may allow the antenna beam generated by the antenna array therein to be scanned toward the far corners of a room that defines the coverage area for the radio node 1000. In some embodiments, the additional antenna array module 1020-5 may not be designed to have beam scanning capability in the elevation plane, since elevation beam scanning may not be particularly helpful when the radio node is mounted in either a ceiling mount or a wall mount configuration. Any of the radio nodes described herein may include an additional antenna array module that has a boresight pointing direction that is perpendicular to a plane define by a main electronics printed circuit board of the radio node.

While certain of the example embodiments of the present invention discussed above include two-state beam switching in the elevation plane as opposed to full beam scanning capabilities, it will be appreciated that embodiments of the present invention are not limited thereto. For example, in other embodiments, the antenna arrays may be designed to have two-state beam switching in the azimuth plane and full beam scanning capabilities in the elevation plane. It will also be appreciated that beam switching may be employed to have more than two states. For example, in other embodiments, radio nodes may be provided that have antenna arrays that perform three-state beam switching in the elevation plane and full beam scanning in the azimuth plane. These antenna arrays may be configured to select one of three possible beam states in the elevation plane.

The radio nodes according to embodiments of the present invention may be particularly useful in mmWave applications where free space loss is very high, and where users are assigned particular time slots in a time division duplex multiple access scheme. In such applications, the users may be associated with a particular beam state so that the antenna beam may adaptively shift on a time slot-by-time slot basis to point in the general vicinity of specific users, thereby providing high gain for each user.

As noted above, the radio nodes according to embodiments of the present invention may work in both wall mount and ceiling mount applications. In some embodiments, the radio nodes may include a sensor (e.g., one or more accelerometers) that is configured to sense an orientation of the radio node. The sensor may be connected to a processor that controls the radio node. In such embodiments, the radio node may be configured to automatically select the beam states that are used in operation (e.g., selecting between the inner and outer beam states in the example of FIG. 13 above) based on an output of the sensor. For example, if the sensor output indicates that the radio node is mounted vertically (which corresponds to a wall mount configuration), then the radio node may automatically bias the PIN diodes D1, D2 to select the outer beam configuration. Conversely, if the radio node is mounted in a ceiling mount configuration, then the radio node may automatically bias the PIN diodes D1, D2 to select the inner beam configuration.

Additionally, the sensor may also be used to determine whether or not all of the antenna arrays may be fed sub-components of an RF signal. For example, if the sensor indicates that the radio node is mounted vertically (wall mount) then it may be programmed to only activate the two antenna arrays on the sides of the radio and to keep the antenna arrays on the top and bottom side inactive to reduce power consumption or to prioritize the side arrays for beam scanning over the top and bottom arrays. Conversely, if the processor senses from the accelerometer that it is mounted horizontally (ceiling mount), then it may be programmed to activate all the antenna arrays to ensure 360° of coverage horizontally. By providing orientation sensing capability within the radio node and appropriate processor programming, capability may be provided in a single radio node design to enable it to optimize the radio node coverage and power consumption using control of the antenna array modules.

The radio nodes according to embodiments of the present invention may provide full hemispherical coverage to support both ceiling mount and wall mount applications within a single design. Techniques are also provided for substantially reducing the total number of phase weighting elements required to provide such capabilities.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

References to “substantially” mean within +/−10% unless expressly defined otherwise. References to “about” mean within +/−5% unless expressly defined otherwise

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A radio node, comprising:
radio frequency (“RF”) circuitry; and
an antenna array that includes a plurality of columns of radiating elements, the antenna array coupled to the RF circuitry,
wherein the antenna array is configured to have a discrete set of beam states in an elevation plane of the antenna array, and
wherein a first subset of the discrete set of beam states is associated with the radio node being mounted in a wall mount configuration and a second subset of the discrete set of beam states is associated with the radio node being mounted in a ceiling mount configuration.

2. (canceled)

3. The radio node of claim 1, wherein a number of beam states in the discrete set of beam states is between two and four beam states.

4. (canceled)

5. The radio node of claim 3, further comprising a base electronics printed circuit board (“PCB”), wherein the antenna array is part of an antenna array module that is mounted on the base electronics PCB.

6. The radio node of claim 5, wherein the antenna array module is a first antenna array module of a plurality of antenna array modules that are mounted on the base electronics PCB, each antenna array module including a respective antenna array.

7. The radio node of claim 6, wherein the antenna array of the first antenna array module defines a first plane that extends at an angle of between about 30° and about 60° with respect to a major surface of the base electronics PCB.

8-10. (canceled)

11. The radio node of claim 1, wherein each of the radiating elements in a first column of the antenna array is connected to a feed line, and wherein a phase weighting element associated with the first column is connected to the feed line by at least a first path and a second path.

12. The radio node of claim 11, wherein the first path connects to a first location on the feed line and the second path connects to a second location on the feed line, where the first and second locations are separated from each other by a first pre-selected phase shift.

13-16. (canceled)

17. An antenna array module, comprising:
a radio frequency (“RF”) input;
a power divider having an input that is coupled to the RF input and at least a first output and a second output;
an antenna array that includes at least a first column of radiating elements and a second column of radiating elements;
a first feed line that connects to each of the radiating elements in the first column of radiating elements;
a second feed line that connects to each of the radiating elements in the second column of radiating elements;
wherein the first output of the power divider is connected to the first feed line by a first path and a second path, and
wherein the second output of the power divider is connected to the second feed line by a third path and a fourth path.

18. The antenna array module of claim 17, wherein the first output of the power divider is selectively connected to the first feed line by one of the first path and the second path.

19. The antenna array module of claim 17, wherein the first path connects to the first feed line at a first location and the second path connects to the first feed line at a second location that is different from the first location.

20. The antenna array module of claim 19, wherein the first location is spaced apart from the second location along the first feed line a distance that corresponds to a phase shift of between 45° and 135° for an RF signal having a frequency that corresponds to a center frequency of the operating frequency band of the antenna array.

21. The antenna array module of claim 20, wherein the first location is spaced apart from the second location along the first feed line a distance that corresponds to a phase shift of about 90° for the RF signal having the frequency that corresponds to the center frequency of the operating frequency band of the antenna array.

22. The antenna array module of claim 19, wherein a top radiating element in the first column connects to the first feed line at a third location and a bottom radiating element in the first column connects to the first feed line at a fourth location, and wherein the first location and the second location are both between the third location and the fourth location.

23. The antenna array module of claim 17, wherein a first diode is coupled to the first path and a second diode is coupled to the second path, and wherein the first and second diodes are configured to allow selection of one of the first path and the second path.

24. The antenna array module of claim 19, wherein the first location is a first end of the first feed line, and wherein the second location is a second end of the first feed line.

25. (canceled)

26. The antenna array module of claim 18, wherein the first output of the power divider is selectively connected to the first feed line by the first path if a radio node that includes the antenna array is mounted in a wall mount configuration, and is selectively connected to the first feed line by the second path if the radio node is mounted in a ceiling mount configuration.

27. A radio node, comprising:
an array of radiating elements that includes at least a first column of radiating elements;
a first feed line that connects to each of the radiating elements in the first column of radiating elements; and
a first phase weighting element that is selectively coupled to the first feed line via a first path and a second path,
wherein the radio node is configured to couple the first phase weighting element to the first feed line via the first path when the radio node is mounted in a wall mount configuration and is configured to couple the first phase weighting element to the first feed line via the second path when the radio node is mounted in a ceiling mount configuration.

28. The radio node of claim 27, wherein the first path connects to the first feed line at a first location and the second path connects to the first feed line at a second location that is different from the first location.

29-30. (canceled)

31. The radio node of claim 28, wherein a top radiating element in the first column connects to the first feed line at a third location and a bottom radiating element in the first column connects to the first feed line at a fourth location, and wherein the first location and the second location are both between the third location and the fourth location.

32. The radio node of claim 27, wherein a first diode is coupled to the first path and a second diode is coupled to the second path, and wherein the first and second diodes are configured to allow selection of one of the first path and the second path.

33-35. (canceled)
